(19) United States
(12) Patent Application Publication
(10) Pub. No.: US 2025/0303761 A1
(43) Pub. Date: Oct. 2, 2025

(54) PRINTER

(71) Applicant: Toshiba Tec Kabushiki Kaisha, Tokyo (JP)

(72) Inventor: Tsuyoshi SANADA, Susono Shizuoka (JP)

(21) Appl. No.: 19/035,725

(22) Filed: Jan. 23, 2025

(30) Foreign Application Priority Data
Mar. 26, 2024 (JP) 2024-050149

(51) Int. Cl. B41J 15/16; B41J 2/315; B41J 11/04

(52) U.S. Cl. CPC B41J 15/165; B41J 2/315; B41J 11/04

(57) ABSTRACT

A printer includes a storage unit in which a roll-shaped printing medium is stored, a print head configured to print on the medium, a first roller that is rotatable to draw out the medium from the storage unit while pressing the medium against the print head, a damper disposed between the storage unit and the print head and against which the medium is pressed as a result of tension in the medium that is drawn out from the storage unit, an elastic body against which the damper is pressed when the medium is pressed against the damper. An elastic force applied to the damper by the elastic body increases as the tension in the medium that is drawn out from the storage unit increases.

### CROSS-REFERENCE TO RELATED APPLICATION(S)

This application is based upon and claims the benefit of priority from Japanese Patent Application No. 2024-050149, filed Mar. 26, 2024, the entire contents of which are incorporated herein by reference.

### FIELD

Embodiments described herein relate generally to a printer.

### BACKGROUND

A printer that prints on a roll-shaped printing medium such as a rolled sheet is known. Such a printer prints on the printing medium while pulling out the wound printing medium. When the printing speed increases rapidly, the load for pulling out the printing medium increases rapidly and may cause slippage of the printing medium in the printer. When this happens, the printer prints characters or the like on the printing medium in a collapsed manner.

Therefore, the printer includes a damper that reduces the load for pulling out the printing medium even when the printing speed is rapidly increased. The damper reduces the load by an elastic force from an elastic body, when the load for pulling out the printing medium rapidly increases.

In recent years, there has been a demand for further increases in printing. When the printing speed becomes high, the load for pulling out the printing medium also increases, so that the elastic body of the damper is required to be harder.

However, when the elastic body of the damper is made hard, the elastic body of the damper does not deform sufficiently when the printing speed rapidly increases while operating in the low-speed range. In such a case, the damper cannot reduce the load for pulling out the printing medium.

### SUMMARY OF THE INVENTION

Embodiments of the present disclosure provide a printer capable of suppressing collapse of printing even when the printing speed changes rapidly in each printing speed range.

A printer comprises a storage unit in which a roll-shaped printing medium is stored, a print head configured to print on the medium, a first roller that is rotatable to draw out the medium from the storage unit while pressing the medium against the print head, a damper disposed between the storage unit and the print head and against which the medium is pressed as a result of tension in the medium that is drawn out from the storage unit, and an elastic body against which the damper is pressed when the medium is pressed against the damper. An elastic force applied to the damper by the elastic body increases as the tension in the medium that is drawn out from the storage unit increases.

### BRIEF DESCRIPTION OF THE DRAWINGS

FIG. 1 is a perspective view illustrating an external appearance of a printer according to an embodiment.

FIG. 2 is a diagram illustrating an example of an internal structure of the printer.

FIG. 3 is a perspective view illustrating an example of a damper mechanism in a state where the damper mechanism is not pushed by a printing medium.

FIG. 4 is a perspective view illustrating an example of the damper mechanism pushed by a printing medium.

FIG. 5 is a perspective view illustrating an example of the damper mechanism in a state in which a damper unit is removed.

FIG. 6 is a graph illustrating a relationship between a load applied to the damper mechanism and a deflection of an elastic body.

FIG. 7 is a diagram illustrating an internal structure of a printer according to Modification 1.

FIG. 8 is a side view illustrating an elastic body according to Modification 2.

### DETAILED DESCRIPTION

Hereinafter, embodiments will be described in detail with reference to the drawings. The present invention is not limited to the embodiments described below.

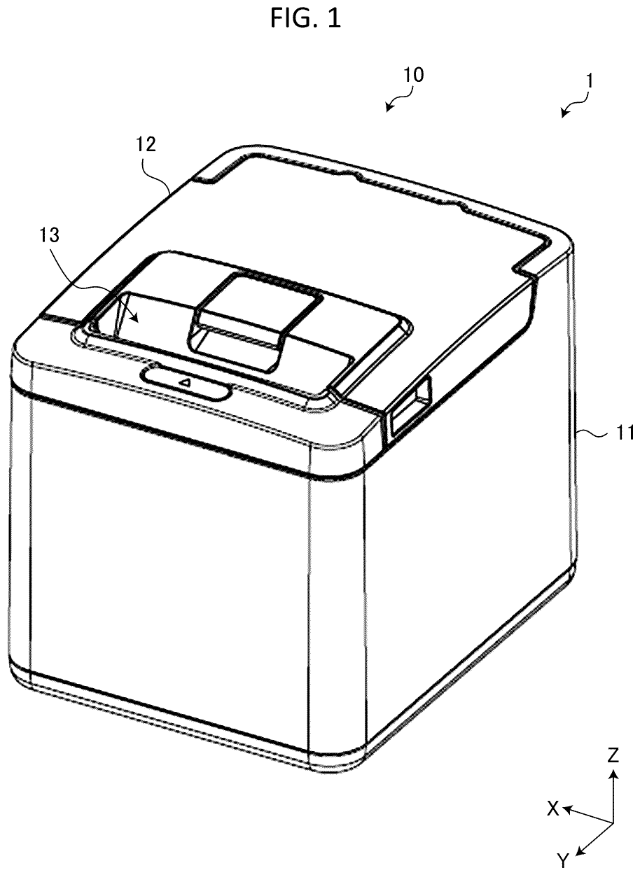

FIG. 1 is a perspective view illustrating an external appearance of a printer 1 according to an embodiment. For example, the printer 1 may be a thermal printer that prints by heat or a printer that prints by ink.

In the drawings described below, for convenience, X-axis, Y-axis, and Z-axis orthogonal to each other are shown, and the left-right direction (i.e., X direction), the front-rear direction (i.e., Y direction), and the up-down direction (i.e., Z direction) will be described using the X-axis, the Y-axis, and the Z-axis. In the following description, when simply referred to as the X direction, the Y direction, or the Z direction, it is the respective axial directions, and includes two directions in opposite directions. In addition, when the positive direction of the X-axis is specified, the direction is one direction from the right side to the left side, when the positive direction of the Y-axis is specified, the direction is one direction from the rear side to the front side, and when the positive direction of the Z-axis is specified, the direction is one direction from the lower side to the upper side.

The printer 1 includes a housing 10. The housing 10 includes a lower housing 11 and an upper cover 12. The lower housing 11 is a box-shaped container in which an opening is provided on one surface. The upper cover 12 is a lid that opens and closes an opening of an upper surface of the lower housing 11. The upper cover 12 is rotatably supported at one side by the lower housing 11, and opens and closes an opening of an upper surface of the lower housing 11 in accordance with the rotation. A discharge port 13 is a gap-shaped opening through which a sheet provided in the upper cover 12 is discharged.

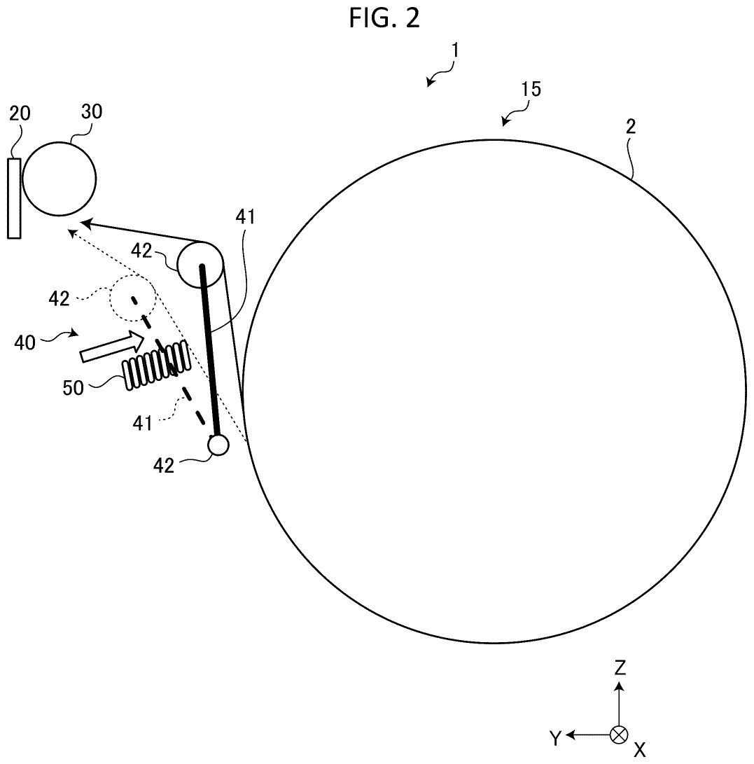

Next, the internal structure of the printer 1 will be described. FIG. 2 is a diagram illustrating an internal structure of the printer 1 according to an embodiment.

The lower housing 11 of the printer 1 stores a storage unit 15, a print head 20, a platen roller 30, and a damper mechanism 40. The storage unit 15 stores a roll-shaped printing medium 2. The printing medium 2 may be a printing sheet of paper to be printed by ink, a thermal sheet to be printed by heat, a label sheet in which labels are arranged on a belt-shaped mount, a label sheet without such a mount, another sheet of paper, or a medium other than paper.

The print head 20 prints on the printing medium 2. That is, the print head 20 transfers the print data to the printing medium 2 by heat, ink, or the like.

The platen roller 30 pulls out the printing medium 2 from the storage unit 15 while pressing the printing medium 2 against the print head 20. The platen roller 30 is a member in which a cylindrical resin is provided around its rotation axis. The motor rotates the rotation shaft of the platen roller 30 at a speed corresponding to the printing speed.

As described above, the platen roller 30 is rotated by the driving of the motor while the printing medium 2 is pressed against the print head 20. As a result, the platen roller 30 causes the print head 20 to print while pulling out the printing medium 2 at a speed corresponding to the printing speed.

The damper mechanism 40 is a member that suppresses a sudden increase in load for pulling out the printing medium 2 and collapse of characters or the like to be printed. More specifically, the damper mechanism 40 pushes the printing medium 2 in the direction indicated by the arrow shown in FIG. 2, thereby reducing the load for pulling out the printing medium 2.

The damper mechanism 40 includes a damper 41, a roller 42, and a rotation unit 43.

The damper 41 pushes the printing medium 2 between the print head 20 and the storage unit 15 by an elastic force that increases stepwise in accordance with a load for pulling out the printing medium 2. For example, the damper 41 pushes the printing medium 2 in the arrow direction shown in FIG. 2 by the elastic force of an elastic body 50.

The damper 41 is a plate-shaped member that connects the roller 42 and the rotation unit 43. The damper 41 is provided with the roller 42 on a side disposed at an upper end in the Z-axis direction. Further, the damper 41 is provided with the rotation unit 43 on a side disposed at a lower end in the Z-axis direction.

The roller 42 is rotatably supported by the damper 41. Further, the roller 42 is in contact with the printing medium 2 conveyed through the conveyance path. The roller 42 rotates to assist the conveyance of the printing medium 2. The rotation unit 43 rotates the damper 41 with a direction substantially parallel to the X-axis direction as a rotation axis.

Here, when the printing speed increases, the load that the platen roller 30 pulls out the printing medium 2 increases. In particular, when the printing speed suddenly increases, the load that the platen roller 30 pulls out the printing medium 2 increases.

In this case, the printing medium 2 pushes back the damper mechanism 40 in the direction opposite to the arrow shown in FIG. 2. For example, the printing medium 2 pushes back to the position represented by the dotted line in FIG. 2. At this time, the damper mechanism 40 gently pushes the printing medium 2 by the elastic force of the elastic body 50. As a result, the load for pulling out the printing medium 2 by the print head 20 and the platen roller 30 is temporarily suppressed. That is, the damper mechanism 40 can prevent the printing medium 2 from slipping and the printing from collapsing.

Next, the damper mechanism 40 will be described in detail.

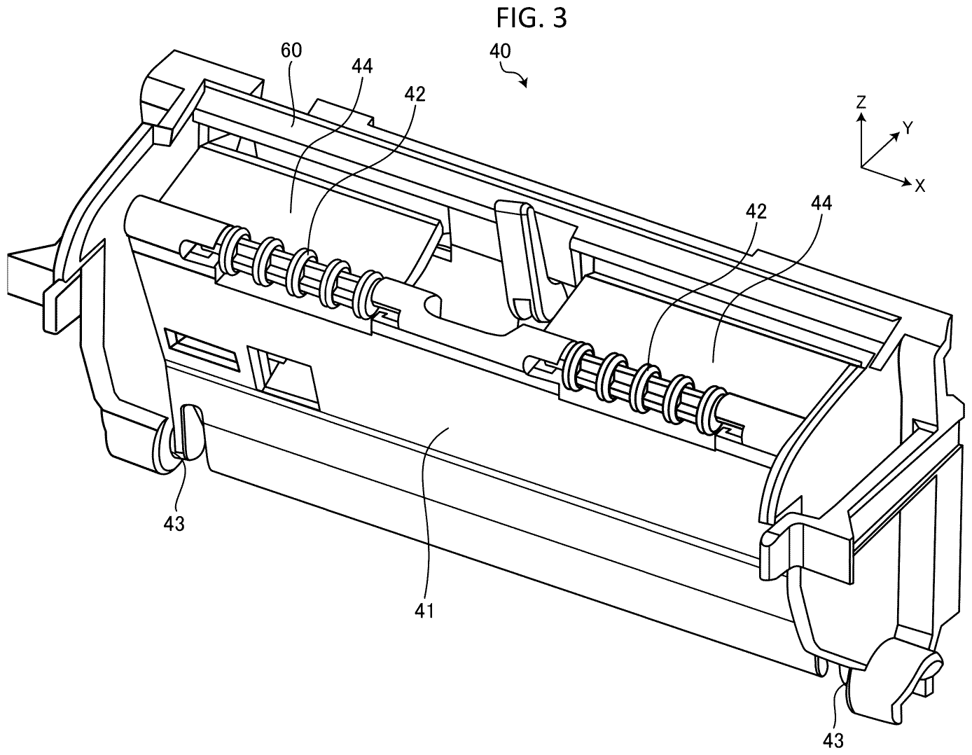

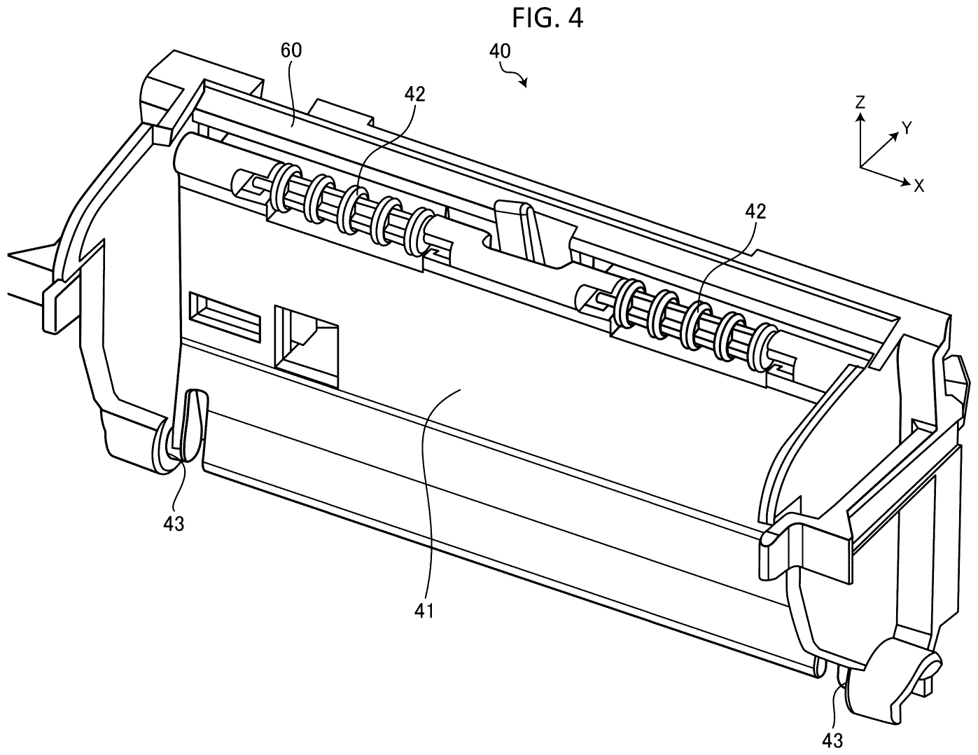

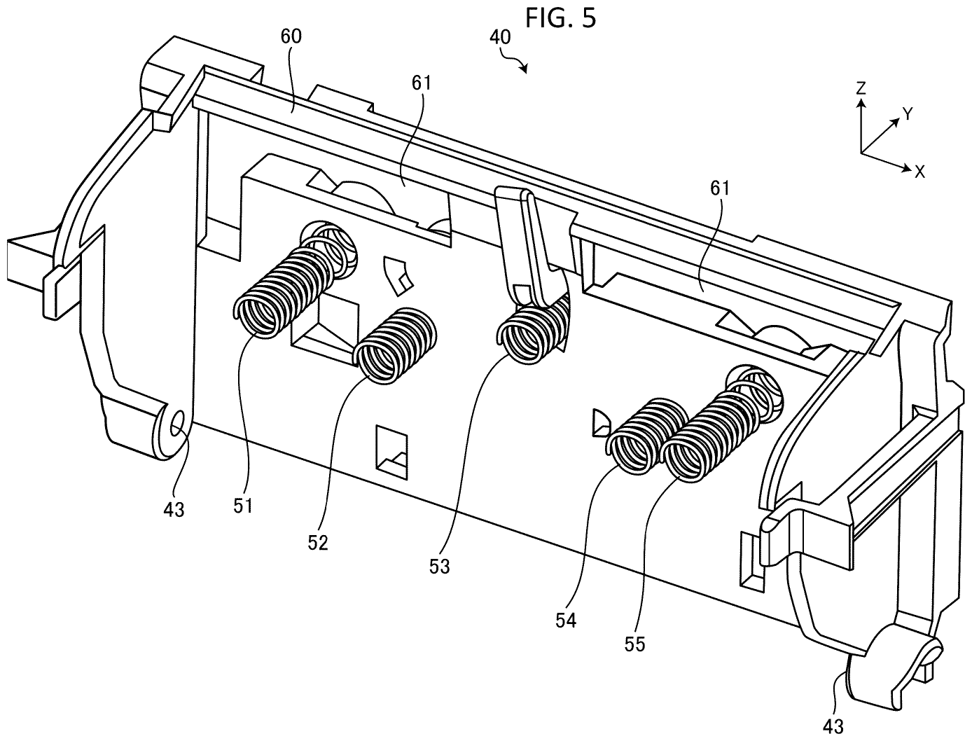

FIG. 3 is a perspective view illustrating an example of the damper mechanism 40 in a state where it is not pushed by the printing medium 2. FIG. 4 is a perspective view illustrating an example of the damper mechanism 40 in a state of being pushed by the printing medium 2. FIG. 5 is a perspective view illustrating an example of the damper mechanism 40 in a state in which the damper 41 is removed.

The damper mechanism 40 includes a support unit 60 that rotatably supports the damper 41. The support unit 60 is a plate-shaped member that rotatably supports the damper 41. The support unit 60 is fixed to the housing 10 or the like.

Further, the support unit 60 is provided with a pair of rotation units 43 at the lower end in the Z-axis direction. The rotation unit 43 has a concave portion substantially parallel to the X-axis direction. In the rotation unit 43, a pair of convex portions provided at the lower end of the damper 41 and substantially parallel to the X-axis direction are inserted. That is, the convex portion provided at the lower end of the damper 41 serves as a rotation axis. The support unit 60 rotatably supports the damper 41 by a rotation shaft provided at the lower end of the damper 41.

As shown in FIG. 5, the support unit 60 has an opening 61 into which the insertion unit 44 of the damper 41 is inserted.

The damper 41 is rotated by a rotation shaft inserted into the rotation unit 43. As a result, the damper 41 can overlap the support unit 60 as shown in FIG. 4. On the other hand, the damper 41 can separate from the support unit 60 as shown in FIG. 3.

The damper 41 has a pair of insertion units 44 to be inserted into the opening 61 of the support unit 60. The insertion unit 44 is a plate-shaped member formed substantially at a right angle to the support unit 60. Further, the insertion unit 44 has a hook portion at a distal end of the side to be inserted into the opening 61 to prevent the insertion unit 44 from coming out of the opening 61. With such a structure, the damper 41 rotates within a range defined by the insertion unit 44.

Further, the support unit 60 has a first elastic body 51, a second elastic body 52, a third elastic body 53, a fourth elastic body 54, and a fifth elastic body 55 on a surface facing the damper 41. In other words, the first elastic body 51, the second elastic body 52, the third elastic body 53, the fourth elastic body 54, and the fifth elastic body 55 are disposed between the damper 41 and the support unit 60, and apply an elastic force stepwise in accordance with a load for pulling out the printing medium 2.

The first elastic body 51, the second elastic body 52, the third elastic body 53, the fourth elastic body 54, and the fifth elastic body 55 apply an elastic force that presses the damper 41 against the printing medium 2. When the first elastic body 51, the second elastic body 52, the third elastic body 53, the fourth elastic body 54, and the fifth elastic body 55 are not distinguished from each other, they are referred to as an elastic body 50.

The elastic body 50 is, for example, a compression coil spring in which metal is wound in a coil shape. The elastic body 50 is disposed at a position sandwiched between the damper 41 and the support unit 60, and rotates by a load for pulling out the printing medium 2, thereby imparting an elastic force.

The first elastic body 51, the second elastic body 52, the third elastic body 53, the fourth elastic body 54, and the fifth elastic body 55 have different lengths. Thus, the first elastic body 51, the second elastic body 52, the third elastic body 53, the fourth elastic body 54, and the fifth elastic body 55 have different timings of being deformed in accordance with the amount of movement of the damper 41 which is rotated by the load for pulling out the printing medium 2. That is, the first elastic body 51, the second elastic body 52, the third elastic body 53, the fourth elastic body 54, and the fifth elastic body 55 have different timings for applying the elastic force.

More specifically, the third elastic body 53 is disposed substantially at the center of the support unit 60. The total length of the third elastic body 53, that is, the length in the Y-axis direction, is shorter than any of the first elastic body 51, the second elastic body 52, the fourth elastic body 54, and the fifth elastic body 55.

The second elastic body 52 is disposed outside the third elastic body 53. The entire length of the second elastic body 52, that is, the length in the Y-axis direction is shorter than the first elastic body 51 and the fifth elastic body 55, and longer than the third elastic body 53. The total length of the second elastic body 52 is approximately the same as the total length of the fourth elastic body 54.

The fourth elastic body 54 is disposed outside the third elastic body 53. More specifically, the fourth elastic body 54 is disposed on the opposite side of the second elastic body 52 with the third elastic body 53 interposed therebetween. The total length of the fourth elastic body 54 is approximately the same as the total length of the second elastic body 52.

The first elastic body 51 is disposed outside the second elastic body 52. Further, the total length of the first elastic body 51, that is, the length in the Y-axis direction, is longer than any of the second elastic body 52, the third elastic body 53, and the fourth elastic body 54. The total length of the first elastic body 51 is approximately the same as the total length of the fifth elastic body 55.

The fifth elastic body 55 is disposed outside the fourth elastic body 54. More specifically, the fifth elastic body 55 is disposed on the opposite side of the first elastic body 51 with the third elastic body 53 interposed therebetween. The total length of the fifth elastic body 55 is approximately the same as the total length of the first elastic body 51.

Here, when the damper 41 is rotated by the load that draws the printing medium 2, the first elastic body 51, the second elastic body 52, the third elastic body 53, the fourth elastic body 54, and the fifth elastic body 55 are deflected. Then, the damper mechanism 40 pushes back the printing medium 2 by the elastic force caused by the deflection of each elastic body 50.

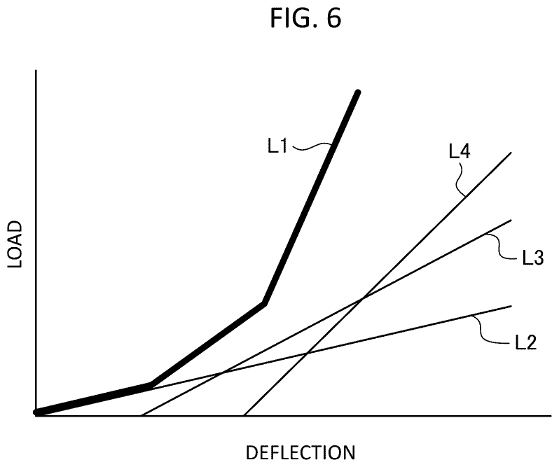

FIG. 6 is a graph showing the relationship between the load applied to the damper mechanism 40 and the deflection of the elastic body 50. The vertical axis of the graph shown in FIG. 6 indicates the load applied to the damper mechanism 40. The horizontal axis of the graph shown in FIG. 6 indicates the amount of displacement of the deflection of each elastic body 50 of the damper mechanism 40.

A line L2 shown in FIG. 6 shows the relation between the load applied to the damper mechanism 40 and the displacement of the deflection of the first elastic body 51 and the deflection of the fifth elastic body 55. A line L3 shown in FIG. 6 shows the relation between the load applied to the damper mechanism 40 and the displacement of the deflection of the second elastic body 52 and the deflection of the fourth elastic body 54. A line L4 shown in FIG. 6 indicates a relation between a load applied to the damper mechanism 40 and a displacement of a deflection of the third elastic member 53. A line L1 shown in FIG. 6 indicates a relation between the elastic force caused by the deflection of the elastic body 50 applied to the damper 41 and the displacement of the damper 41.

As shown in FIG. 6, the first elastic body 51 and the fifth elastic body 55 have the longest overall length and come into contact with the damper 41 from the beginning. Therefore, as indicated by the line L2, the first elastic body 51 and the fifth elastic body 55 apply the deflection and the elastic force from the beginning.

Further, as shown in FIG. 6, the second elastic body 52 and the fourth elastic body 54 are shorter than the first elastic body 51 and the fifth elastic body 55, and longer than the third elastic body 53. Therefore, the second elastic body 52 and the fourth elastic body 54 contact the damper 41 at a timing indicated by the line L3. That is, the second elastic body 52 and the fourth elastic body 54 applies the deflection and the elastic force at the times indicated by the line L3.

As shown in FIG. 6, the third elastic member 53 has the shortest overall length and contacts the damper 41 at a timing indicated by the line L4. That is, the third elastic member 53 applies the deflection and the elastic force at the times indicated by the line L4.

As indicated by the line L2, the line L3, and the line L4, the elastic body 50 deflects in accordance with the loads applied to the damper mechanisms 40. As a result, the damper mechanism 40 can increase the elastic force stepwise in accordance with the load applied by the printing medium 2. That is, the damper 41 pushes the printing medium 2 by an elastic force that is gradually increased by the plurality of elastic bodies 50 having different timings of being deformed in accordance with the amount of movement of the damper 41 which is rotated by the load for pulling out the printing medium 2.

Note that the timing at which each elastic body 50 and the damper 41 come into contact with each other is not limited to the adjustment of the length of each elastic body 50, and may be adjusted by other methods. For example, even if the lengths of the elastic bodies 50 are the same, the timing at which the elastic bodies 50 and the damper 41 come into contact with each other can be adjusted by arranging the elastic bodies 50 in a concave portion or a convex portion provided in the support unit 60. Alternatively, the timing at which the elastic body 50 and the damper 41 come into contact with each other may be adjusted by providing a concave portion or a convex portion at a portion of the damper 41 where each elastic body 50 comes into contact with each other.

As described above, the printer 1 includes the damper 41 that pushes the printing medium 2 between the print head 20 and the storage unit 15 by the elastic force that increases stepwise in accordance with the load for pulling out the printing medium 2. As described above, since the elastic force changes stepwise, the printer 1 can prevent the printing from being crushed even when the printing speed changes abruptly in each printing speed range.

### (Modification 1)

The printer 1 has been described in which the printing medium 2 is pushed back by the elastic force of the first elastic body 51, the second elastic body 52, the third elastic body 53, the fourth elastic body 54, and the fifth elastic body 55. However, a printer 1a according to Modification 1 may have a tension coin spring 72 instead of at least one of the elastic bodies 50 or together with the elastic bodies 50.

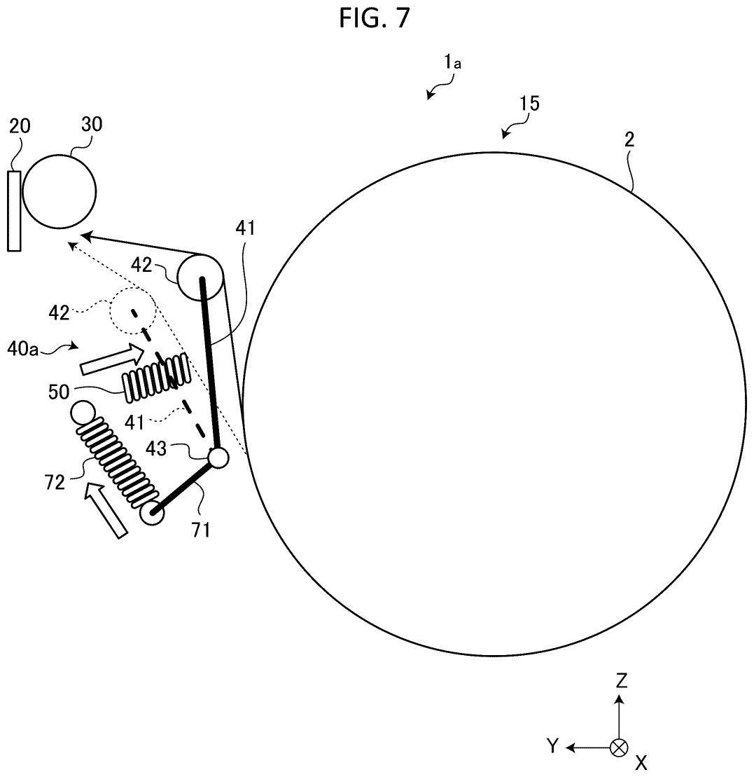

FIG. 7 is a diagram illustrating an interior configuration of the printer 1a according to Modification 1. For example, the damper 41 has a connecting unit 71. The connecting unit 71 is a member that connects the damper 41 and the tension coin spring 72. The connecting unit 71 is disposed so as to be orthogonal to the damper 41. The tension coin spring 72 may press the roller 42 against the printing medium 2 by pulling the connecting unit 71 by an elastic force.

### (Modification 2)

The elastic body 50 has been described as a compression coil spring. However, the elastic body 50b may be made of a plastic material such as rubber.

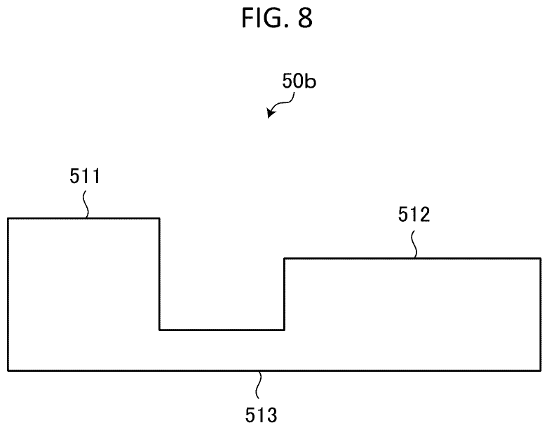

FIG. 8 is a side view illustrating an exemplary elastic body 50b according to Modification 2. The elastic body 50b includes a first protrusion 511, a second protrusion 512, and a coupling surface 513. The first protrusion 511 is a protrusion in contact with the damper 41. The second protrusion portion 512 is a protrusion that contacts the damper 41. The second protrusion 512 is lower than the first protrusion 511. Therefore, the second protruding portion 512 comes into contact with the damper 41 when the first protruding portion 511 and the damper 41 come into contact with each other and a load is applied to the damper mechanism 40.

The coupling surface 513 is a surface that couples the elastic body 50b and the support unit 60. The elastic body 50b and the support unit 60 may be bonded by an adhesive, or may be bonded by a fixing tool such as a screw.

The elastic body 50b is coupled to the support unit 60 instead of the elastic body 50 illustrated in FIG. 5. In addition, the elastic body 50b may be coupled such that the longitudinal direction of the elastic body 50b and the X-axis direction are substantially parallel to each other, or may be coupled such that the longitudinal direction of the elastic body 50b and the Z-axis direction are substantially parallel to each other, or may be coupled by other angles.

With such a configuration, the damper 41 pushes the printing medium 2 with an elastic force that increases stepwise by an elastic body 50b having a plurality of projections whose times vary depending on the displacement of the damper 41 that rotates by the load for pulling out the printing medium 2.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a storage unit in which a roll-shaped printing medium is stored;
a print head configured to print on the medium;
a first roller that is rotatable to draw out the medium from the storage unit while pressing the medium against the print head;
a damper disposed between the storage unit and the print head and against which the medium is pressed as a result of tension in the medium that is drawn out from the storage unit;
an elastic body against which the damper is pressed when the medium is pressed against the damper, wherein
an elastic force applied to the damper by the elastic body increases as the tension in the medium that is drawn out from the storage unit increases.

2. The printer according to claim 1, wherein
the elastic body includes one or more elastic members by which the elastic force is generated.

3. The printer according to claim 2, wherein
the elastic members are coil springs.

4. The printer according to claim 3, wherein
a length of one of the coil springs is different from a length of another one of the coil springs so that the damper: at a first position is in contact with the one coil spring but not the another coil spring, and at a second position is in contact with both the one coil spring and the another coil spring.

5. The printer according to claim 3, wherein
the coil springs include a first coil spring, a second coil spring, and a third coil spring that is between the first and second coil springs, and
a length of the third coil spring is shorter than a length of the first spring and longer than the second coil spring so that the damper: at a first position is in contact with the first coil spring but not with the second and third coil springs, at a second position is in contact with the first and third coil springs but not with the second coil spring, and at a third position is in contact with the first, second, and third coil springs.

6. The printer according to claim 3, wherein
the coil springs include two coil springs, each of which generates an elastic force of a different magnitude.

7. The printer according to claim 2, wherein
the elastic members are protrusions having different heights.

8. The printer according to claim 2, wherein
a number of the elastic members that contact the damper when the medium is drawn out varies depending on the tension in the medium.

9. The printer according to claim 2, wherein
the damper includes a second roller against which the medium that is drawn out is pressed, and a pivot point about which the damper rotates to be pressed against one or more of the elastic members as the medium is drawn out.

10. The printer according to claim 1, wherein
the medium is a thermal sheet.

11. A printer comprising:
a storage unit in which a roll-shaped printing medium is stored;
a print head configured to print on the medium;
a first roller that is rotatable to draw out the medium from the storage unit while pressing the medium against the print head;
a damper that is rotatable and contacts the medium between the storage unit and the print head;
a support plate that rotatably supports the damper; and
a plurality of elastic members between the damper and the support plate, wherein
the elastic members include a first elastic member and a second elastic member, and a first height of the first elastic member is different from a second height of the second elastic member.

12. The printer according to claim 11, wherein
a first elastic force generated by the first elastic member is different from a second elastic force generated by the second elastic member.

13. The printer according to claim 11, wherein
the elastic members are coil springs.

14. The printer according to claim 13, wherein
the elastic members include a third elastic member between the first and second elastic members and having a third height, and
the third height is lower than the first height and higher than the second height.

15. The printer according to claim 14, wherein
the second elastic member is located at a center of the damper in a longitudinal direction thereof.

16. The printer according to claim 11, wherein
the elastic members are protrusions on the support plate.

17. The printer according to claim 16, wherein
the elastic members include a third elastic member between the first and second elastic members and having a third height, and
the third height is lower than the first and second heights.

18. The printer according to claim 11, wherein
a number of the elastic members that contact the damper when the medium is drawn varies depending on a tension load applied to the medium.

19. The printer according to claim 11, wherein
the damper includes a second roller that contacts the medium.

20. The printer according to claim 11, wherein
the medium is a thermal sheet.
